(19) United States
(12) Patent Application Publication
(10) Pub. No.: US 2005/0079000 A1
(43) Pub. Date: Apr. 14, 2005

(54) Applicator with piston

(76) Inventor: Garry Isaur, Rowland Heights, CA (US)

Correspondence Address: JOE NIEH, 18760 E. AMAR ROAD #204, WALNUT, CA, 91789, US

(21) Appl. No.: 10/681,977

(22) Filed: Oct. 9, 2003

(51) Int. Cl. B43K 5/06; B05C 17/015

(52) U.S. Cl. 401/176; 401/171; 401/183

(57) ABSTRACT

A self-contained applicator with a sealed applicator tip enclosing a liquid or a viscous substance is disclosed. The applicator with piston comprises of an elongated housing with a sealed applicator tip at one end and a piston near the other end with a liquid or viscous substance disposed between them. The liquid or viscous substance is sealed within the applicator and may be extracted from the applicator through the applicator tip when the piston is urged towards the applicator tip.

### BACKGROUND—FIELD OF INVENTION

The present invention relates generally to an applicator that is fully sealed and encloses a liquid or a viscous substance. More specifically the present invention is an applicator that is completely sealed along with a liquid or viscous substance that can be extracted through the applicator by a piston.

### BACKGROUND—DESCRIPTION OF RELATED ART

Applicators for liquids and viscous substances such as creams come in various forms and sizes. A common applicator is the cotton swab that comprises of an elongated handle and an absorbent tip at one or both ends of the elongated handle. The elongated handle may be made of a variety of material such as wood, paper, or plastic. The elongated handle may be a solid member or a hollow tube. The absorbent tip may be made of cotton or foam. Generally, the absorbent tip of the cotton swab is placed in contact with the liquid so that the absorbent tip will absorb the liquid. The moisturized absorbent tip is then placed in contact with the surface to apply the liquid to the surface. The absorbent tip may also be place in contact with a viscous substance such that some of the viscous substance will attach themselves to the absorbent tip to be retrieved and applied to desired locations. Some designs incorporate the liquid into the hollow tube of the elongated handle to form a self-contained applicator. However, these designs are not generally suitable for viscous substances such as creams or lotions because the viscous substance will not flow out of the hollow tube easily. The present invention is suitable for use with both liquids and viscous substances.

### SUMMARY OF THE INVENTION

The present invention is a self-contained applicator with a sealed applicator tip enclosing a liquid or a viscous substance. The liquid or viscous substance may be easily applied by the applicator tip when a piston within the applicator is urged to extract the enclosed liquid or viscous substance from the applicator. The applicator with piston comprises of an elongated housing with a sealed applicator tip at one end and a piston near the other end with a liquid or viscous substance disposed between them. The liquid or viscous substance is sealed within the applicator and may be extracted through the applicator tip when the piston is urged towards the applicator tip.

### BRIEF DESCRIPTION OF THE DRAWINGS

FIG. 1 shows the preferred embodiment of the applicator with piston.

FIG. 2 shows another embodiment of the applicator with piston.

FIG. 3 shows another embodiment of the applicator with piston.

FIG. 4 shows another embodiment of the applicator with piston.

FIG. 5 shows another embodiment of the applicator with piston.

### DETAILED DESCRIPTION OF THE PREFERRED EMBODIMENT

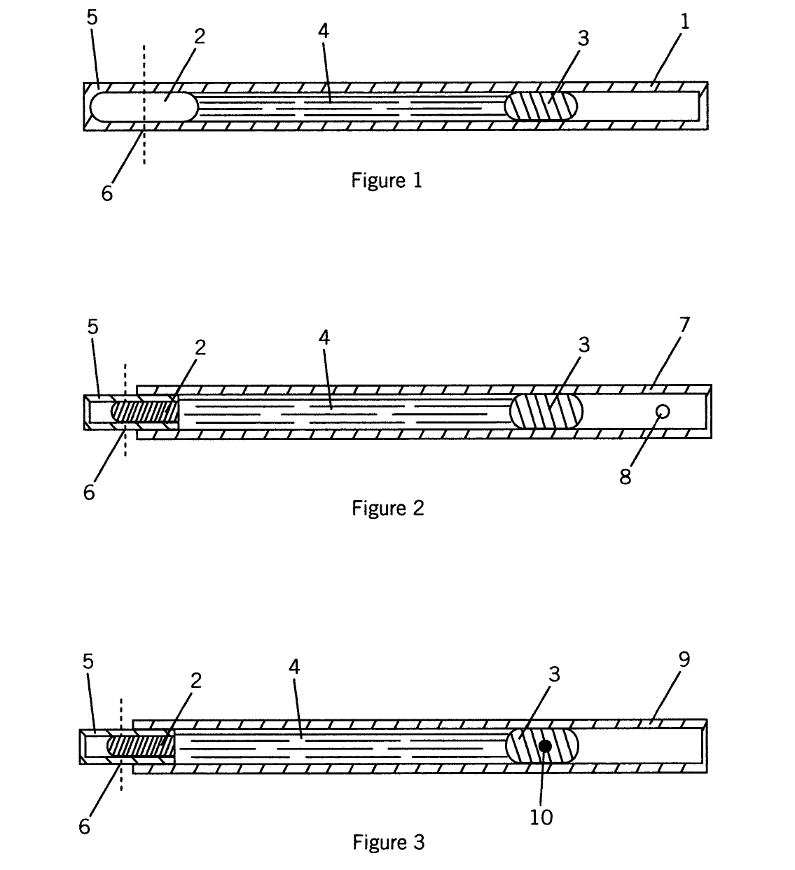

FIG. 1 shows the preferred embodiment of the present invention. In the preferred embodiment, the applicator with piston comprises of an elongated tubular housing 1 with a sealed applicator tip 2 at one end 5 and a piston 3 disposed near the other sealed end with a liquid or viscous substance 4 disposed between them. An opening means 6 such as a fracture line is provided at the location of the applicator tip 2 which will allow the sealed end 5 to be removed to expose the applicator tip 2. The applicator tip 2 may also be made of a rigid material with a hole formed through it to allow the enclosed liquid or viscous substance 4 to be released. The hole may be sealed with a removable plastic or aluminum film. The liquid or viscous substance 4 is sealed within the elongated tubular housing 1 and may be extracted through the applicator tip 2 when the piston 3 is urged towards the applicator tip 2 by applying pressure on the elongated tubular housing 1 with the user's finger from the end opposite from the liquid or viscous substance 4.

FIG. 2 shows another embodiment of the applicator with piston comprising an elongated tubular housing 7 with a sealed applicator tip 2 at one end and a piston 3 disposed near the other sealed end with a liquid or viscous substance 4 disposed between them. The applicator tip 2 may be sealed with a cap 5 with a fracture line 6 formed that will allow the cap 5 to be removed to expose the applicator tip 2. The applicator tip 2 may also be made of a rigid material with a hole formed through it to allow the enclosed liquid or viscous substance 4 to be released. A hole 8 is located between the sealed end of the elongated tubular housing 7 and the piston 3. The liquid or viscous substance 4 is sealed within the elongated tubular housing 7 and may be extracted through the applicator tip 2 when the piston 3 is urged towards the applicator tip 2 by pressure from the user's finger from the end opposite from the liquid or viscous substance 4. The hole 8 disposed between the sealed end and the piston 3 will allow entry of air into the elongated tubular housing 7 so that the elongated tubular housing 7 may return to its original shape when pressure from the user's finger is released from the elongated tubular housing 7.

FIG. 3 shows another embodiment of the applicator with piston comprising an elongated tubular housing 9 with a sealed applicator tip 2 at one end and a piston 3 disposed near the other sealed end with a liquid or viscous substance 4 disposed between them. The applicator tip 2 may be sealed with a cap 5 with a fracture line 6 formed that will allow the cap 5 to be removed to expose the applicator tip 2. The applicator tip 2 may also be made of a rigid material with a hole formed through it to allow the enclosed liquid or viscous substance 4 to be released. A hole 10 is located at the location of the piston 3 and sealed by the piston 3. The liquid or viscous substance 4 is sealed within the elongated tubular housing 9 and may be extracted through the applicator tip 2 when the piston 3 is urged towards the applicator tip 2 by pressure from the user's finger from the end opposite from the liquid or viscous substance 4. The hole 10 located above the piston 3 will be exposed and will allow entry of air into the elongated tubular housing 9 so that the elongated tubular housing 9 may be returned to its original shape when pressure from the user's finger is released form the elongated tubular housing 9.

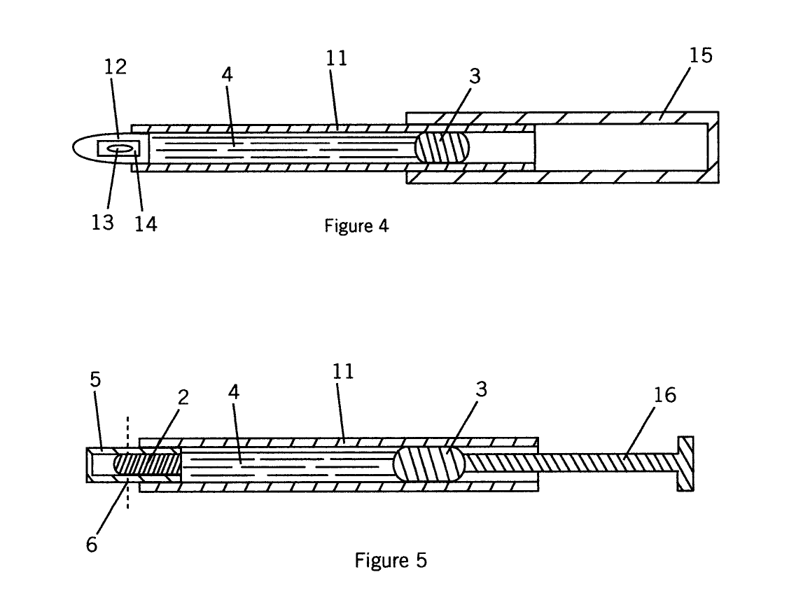

FIG. 4 shows another embodiment of the applicator with piston comprising an elongated tubular housing 11 with a sealed applicator tip 12 at one end and a piston 3 disposed near the other open end with a liquid or viscous substance 4 disposed between them. The applicator tip 12 may be made of a rigid material with a hole 13 formed through it to allow the enclosed liquid or viscous substance 4 to be released. The hole 13 may be sealed with a removable plastic or aluminum film 14. The applicator tip 12 may also be sealed with a cap with a fracture line formed that will allow the cap to be removed to expose the applicator tip 12. The liquid or viscous substance 4 is sealed within the elongated tubular housing 11 and may be extracted through the applicator tip 12 when the piston 3 is urged towards the applicator tip 12 by pressure from a compression member 15. The compression member 15 is a hollow elongated member with an open end and a sealed end. The open end has an inside diameter approximately that of the outside diameter of the elongated tubular housing 11 and slides over the open end of the elongated tubular housing 11. When the compression member 15 is pushed toward the piston 3, the enclosed air is compressed and will exert a pressure on the piston 3 to urge it to extract the enclosed liquid or viscous substance 4 out of the elongated tubular housing 11 through the applicator tip 12.

FIG. 5 shows another embodiment of the applicator with piston comprising an elongated tubular housing 11 with a sealed applicator tip 2 at one end and a piston member 16 disposed at the other open end with a liquid or viscous substance 4 disposed between them. The applicator tip 2 may be sealed with a cap 5 with a fracture line 6 formed that will allow the cap 5 to be removed to expose the applicator tip 2. The applicator tip 2 may also be made of a rigid material with a hole formed through it to allow the enclosed liquid or viscous substance 4 to be released. The liquid or viscous substance 4 is sealed within the elongated tubular housing 11 and may be extracted through the applicator tip 2 when the piston member 16 is urged towards the applicator tip 2 by applying pressure with the user's finger at the end of the piston member 16. The piston member 16 has a piston head 3 with approximately the same outside diameter as the inside diameter of the elongated tubular housing 11 and an elongated slender body. When the piston member 16 is pushed toward the enclosed liquid or viscous substance 4, the enclosed liquid or viscous substance 4 will be extracted out of the elongated tubular housing 11 through the applicator tip 2.

Although the description above contains many specificities, these should not be construed as limiting the scope of the invention but as merely providing illustrations of some of the presently preferred embodiments of this invention. Thus the scope of the invention should be determined by the appended claims and their legal equivalents, rather than by the examples given.

1. An applicator with piston comprising:
an elongated tubular housing with a sealed applicator tip at one end and a piston disposed near the other sealed end with a liquid or viscous substance disposed between them, and
an opening means provided at the location of the applicator tip which will allow the sealed end to be removed to expose the applicator tip,
wherein the liquid or viscous substance is sealed within the elongated tubular housing and may be extracted through the applicator tip when the piston is urged towards the applicator tip by applying pressure on the elongated tubular housing with the user's finger from the end opposite from the liquid or viscous substance.

2. An applicator with piston as in claim 1, wherein said opening means is a fracture line on the elongated tubular housing.

3. An applicator with piston as in claim 1, wherein said applicator tip is made of a rigid material defining a hole that is covered with a film.

4. An applicator with piston as in claim 1, wherein a hole is defined by said elongated tubular housing located between said piston and said sealed end.

5. An applicator with piston as in claim 1, wherein a hole is defined by said elongated tubular housing located at the same location as the piston and covered by the piston.

6. An applicator with piston as in claim 2, wherein a hole is defined by said elongated tubular housing located between said piston and said sealed end.

7. An applicator with piston as in claim 2, wherein a hole is defined by said elongated tubular housing located at the same location as the piston and covered by the piston.

8. An applicator with piston as in claim 3, wherein a hole is defined by said elongated tubular housing located between said piston and said sealed end.

9. An applicator with piston as in claim 3, wherein a hole is defined by said elongated tubular housing located at the same location as the piston and covered by the piston.

10. An applicator with piston comprising:
an elongated tubular housing with a sealed applicator tip at one end and a piston disposed near the other open end with a liquid or viscous substance disposed between them,
an opening means provided at the location of the applicator tip which will allow the sealed end to be removed to expose the applicator tip,
a compression member comprising a hollow elongated member with an open end and a sealed end wherein the open end has an inside diameter approximately that of the outside diameter of the elongated tubular housing and slides over the open end of the elongated tubular housing,
wherein when the compression member is urged toward the piston, the enclosed air is compressed and will exert a pressure on the piston to urge it to extract the enclosed liquid or viscous substance out of the elongated tubular housing through the applicator tip

11. An applicator with piston as in claim 10, wherein said opening means is a fracture line on the elongated tubular housing.

12. An applicator with piston as in claim 10, wherein said applicator tip is made of a rigid material defining a hole that is covered with a film.

13. An applicator with piston comprising:
an elongated tubular housing with a sealed applicator tip at one end and an open end with a liquid or viscous substance disposed therein,
an opening means provided at the location of the applicator tip which will allow the sealed end to be removed to expose the applicator tip,
a piston member with a piston head with approximately the same outside diameter as the inside diameter of the elongated tubular housing and an elongated slender body is disposed near the open end,
wherein when the piston member is urged toward the enclosed liquid or viscous substance it will force the enclosed liquid or viscous substance out of the elongated tubular housing through the applicator tip.

14. An applicator with piston as in claim 13, wherein said opening means is a fracture line on the elongated tubular housing.

15. An applicator with piston as in claim 13, wherein said applicator tip is made of a rigid material defining a hole that is covered with a film.
